(19) United States
(12) Patent Application Publication
(10) Pub. No.: US 2026/0327924 A1
(43) Pub. Date: Oct. 22, 2026

(54) A FIRE-BLOCKING DEVICE FOR A STAY CABLE CAPABLE OF ACHIEVING BIDIRECTIONAL EXPANSION WHEN EXPOSED TO HEAT AND AN INSTALLATION METHOD THEREOF

(71) Applicant: JIANGSU FASTEN STEEL CABLE CO., LTD., Jiangyin Wux (CN)

(72) Inventors: Pengfei XIA, Jiangyin Wuxi (CN); Huajuan XUE, Jiangyin Wuxi (CN); Jun ZHAO, Jiangyin Wuxi (CN); Qiong WU, Jiangyin Wuxi (CN)

(21) Appl. No.: 18/992,081

(22) PCT Filed: Aug. 23, 2024
(86) PCT No.: PCT/CN2024/114142

§ 371 Date: Jan. 7, 2025

(30) Foreign Application Priority Data
Dec. 19, 2023 (CN) 20231174853.9

(51) Int. Cl. E01D 19/16; E01D 11/04

(52) U.S. Cl. CPC E01D 19/16; E01D 11/04

(57) ABSTRACT

A fire-blocking device for a stay cable capable of achieving bidirectional expansion when exposed to heat includes a fire-blocking ring and a positioning fixture. The fire-blocking ring is fixed on the surface of a cable body of the stay cable by the positioning fixture. The fire-blocking ring wraps the cable body of the stay cable. The fire-blocking ring expands inwards when heated to hug the cable body of the stay cable tightly, and expands outwards to separate the cable bodies of the stay cable on two sides of the fire-blocking ring. A weather-resistant fireproof tape is wound around the cable body of the stay cable where the fire-blocking ring is arranged. The fire-blocking ring is arranged on the outer side of the fireproof tape. The fire-blocking ring comprises a fire-blocking-ring shell and a fire-blocking core material. The fire-blocking core material is arranged inside the fire-blocking-ring shell.

### TECHNICAL FIELD

The present invention relates to a fire-blocking device for a stay cable, in particular to a fire-blocking device based on the principle of thermal expansion, and an installation method thereof.

### BACKGROUND ART

During the service of a cable-stayed bridge, smoke and fire broke out near the main tower in the No. 2 stay cable in the eastern half of the bridge. Relevant departments including building, design, construction, firefighting, and traffic police rushed to the scene as soon as possible to handle the matter. The No. 2 stay cable broke and fell to the bridge deck, causing neither casualties nor damage to vehicles. Preliminary analysis showed that the cause of the fire was a short circuit in the wire joint of the No. 2 stay cable lighting line, which caused local fire in the cable. Due to the lack of a fire-blocking device, the flames spread along the cable sheath and cable body, causing some temperature-sensitive cable-bearing components to deform and break.

There are two main types of stay cables which are widely used in the field of cable-stayed bridges, i.e. parallel steel-wire stay cable and steel-strand stay cable. Parallel steel-wire stay cable is produced by arranging high-strength galvanized or zinc-aluminum-alloy steel wires tightly in a regular hexagon or in an incomplete hexagon, lightly twisting to the left at a twist angle of 2° to 4°, and then wrapping with a high-strength polyester fiber belt to the right. A high-density polyethylene (PE) sheath is directly hot-extruded on the outer side of the steel wire for protection, and is equipped with a cold-cast heading anchor. The free section of the parallel steel-wire stay cable adopts a double-layer protection system of galvanized-aluminum-alloy steel wire+double-layer hot-extruded HDPE sheath.

The steel-strand stay cable is a steel strand bundle composed of a single steel strand with a hot-extruded polyethylene (PE) sheath. The outer layer of the entire cable bundle is a double-layer synchronously-extruded high-density polyethylene (HDPE) protective sheath which forms a free telescopic section, and two ends are equipped with a clip-type tensioning-end anchor (including a nut) and a fixing-end anchor (without a nut) respectively. The free section of the steel-strand stay cable adopts a four-layer protection system on the steel strand, wherein the four-layer protection system comprises galvanized/epoxy layer+oily wax+hot-extruded PE sheath for the steel strand+HDPE outer sheath.

In the above-mentioned two types of cable-stayed structures, the main load-bearing component (the steel wire) has a high melting point. Short-term exposure to heat will only cause a decrease in strength and elastic modulus, and the possibility of breakage is small. However, since the high-density polyethylene sheath that protects the stay cable wire has a low softening point, a low melting point and a low ignition point, it can soften at around 120° C., melt at around 200° C. and burn at around 342° C. Therefore, when a fire occurs in the stay cable, the high-density polyethylene sheath will soften and melt first. When it burns to a certain extent, the high-density sheath will burn. After burning, the flame can spread along the polyethylene sheath of the stay cable. If the high-density polyethylene sheath is melted, deformed, or even burned by the flame and high temperature to form holes, the flame can further spread through the holes, increasing the fire damage area of the stay cable. In addition, for the steel-strand stay cable system, there is a large amount of grease on the cable body and at the anchoring points. Grease is a combustion-supporting material which will accelerate the spread of fire. Therefore, it is very important for fire prevention of the stay cable to prevent and block the spread of flames on the polyethylene sheath and on the cable body of the stay cable.

### SUMMARY OF INVENTION

In view of the existing conditions of stay cables, the present invention provides a fire-blocking device for a stay cable capable of achieving bidirectional expansion when exposed to heat, and an installation method. It is installed on the stay cable and is used for preventing the spread of fire.

The technical solution adopted by the present invention is a fire-blocking device for a stay cable capable of achieving bidirectional expansion when exposed to heat, including a fire-blocking ring and a positioning fixture. The fire-blocking ring is fixed on the surface of the cable body of the stay cable by the positioning fixture, and the fire-blocking ring wraps the cable body of the stay cable. If being heated, the fire-blocking ring expands inward to hug the cable body of the stay cable tightly, and expands outward to separate the cable bodies of the stay cable on two sides of the fire-blocking ring.

As an embodiment of the present application, the fire-blocking ring has an integrated structure, and the cable body of the stay cable passes through the fire-blocking ring; or the fire-blocking ring has a half-type structure, and is arranged around the cable body of the stay cable.

As an embodiment of the present application, a weather-resistant fireproof tape is wound around the cable body of the stay cable where the fire-blocking ring is arranged, and the fire-blocking ring is arranged outside the fireproof tape. The fire-blocking ring does not directly contact the cable body, thereby avoiding crushing damage to the high-density polyethylene layer on the surface of the cable body.

As an embodiment of the present application, the fire-blocking ring includes a fire-blocking-ring shell, a fire-blocking core material and a clamp, wherein the fire-blocking core material is arranged inside the fire-blocking-ring shell, and the clamp is clamped outside the fire-blocking-ring shell. The fire-blocking-ring shell is used to provide daily protection for the fire-blocking core material, thereby reducing the interference of the environment on the fire-blocking core material. The fire-blocking-ring shell is preferably made of high-density polyethylene.

As an embodiment of the present application, the fire-blocking core material has an annular structure, and the fire-blocking-ring shell is a hollow annular structure. The fire-blocking-ring shell includes a fire-blocking-ring cylinder, a fire-blocking-ring upper cover plate, and a fire-blocking-ring lower cover plate. The fire-blocking core material is arranged inside the fire-blocking-ring cylinder. The fire-blocking-ring upper cover plate and the fire-blocking-ring lower cover plate are respectively arranged at an upper opening and a lower opening of the fire-blocking-ring cylinder body, so that fire-blocking core material is fixed inside the fire-blocking-ring cylinder.

As an embodiment of the present application, the fire-blocking-ring shell is made of high-density polyethylene, with a thickness of not less than 3 mm. The inner diameter of the fire-blocking-ring shell is 1 to 3 mm larger than the outer diameter of the stay cable.

The settings of the inner diameter D1, the outer diameter D2 and the height H of the fire-blocking core material are shown in the below table.

| | Inner diameter D1 of | Outer diameter D2 of | Height H of the |
|---|---|---|---|
| Outer diameter D of | the fire-blocking core | the fire-blocking core | fire-blocking core |
| stay cable | material | material | material |
| D ≤ 110 mm | D + 1 mm | D + 21 mm | 60-80 mm |
| 110 mm < D ≤ 160 mm | D + 2 mm | D + 32 mm | 70-90 mm |
| 160 mm < D ≤ 210 mm | D + 2 mm | D + 42 mm | 80-10 0 mm |
| 210 mm < D | D + 3 mm | D + 43 mm | 90-110 mm |

As an embodiment of the present application, a positioning groove is provided by processing on the surface of the fire-blocking-ring shell. The positioning groove is used for arranging the clamp. The clamp fixes the fire-blocking-ring shell of the half-type structure as a whole. The fire-blocking-ring shell adopts a half-type structure, which facilitates the installation of the fire-blocking ring, the adjustment of the position of the fire-blocking ring on the cable body, and the subsequent maintenance and updating.

As an embodiment of the present application, the positioning fixture is arranged at the lower end of the fire-blocking ring. The bottom of the fire-blocking ring is supported by the positioning fixture. The positioning fixture has a half-type structure, which is provided outside the stay cable. The inner hole of the positioning fixture is provided with a silicone rubber with a thickness of 5 mm to 10 mm. The silicone rubber is wrapped around the outer side of the stay cable. Using silicone rubber to contact the cable body, the polyethylene sheath layer on the surface of the cable body can be protected daily, and it can avoid damage to the cable body surface during installation of the position fixture.

As an embodiment of the present application, a connecting hole is provided on the surface of the positioning fixture. The positioning fixture is connected to the fire-blocking ring by arranging a connecting member in the connecting hole, or by providing a limiting member in the connecting hole to form an external limit to the fire-blocking ring, so as to realize reliable support and positioning of the fire-blocking ring by the positioning fixture.

Fires in stay cables are mainly caused by the burning of vehicles driving on the bridge deck or the construction work at the tower end/beam end. Therefore, it is necessary to install fire-blocking devices that can achieve bidirectional expansion when exposed to heat (both inward and outward) at the key locations such as outside the pre-buried pipe at the beam end, the flame impact zone of vehicle burning, the tower end, etc., This will form an isolation at the fire position of the stay cable, block the flame from spreading along the surface of the cable body, and prevent the flame after the high-density polyethylene sheath burns from spreading along the cable body, and from causing more disasters.

The fire-blocking device provided by the present application has a simple structure and is easy to install on the cable body. It is not interfered by the stay cable's own structure and is easy to promote and apply. The present application uses a bidirectional expansion fire-blocking core material as the core component of the fire-blocking. It takes advantage of its thermal expansion characteristics to hug the cable body inward to prevent the spread of flames, and expand outward to separate the cable bodies on two sides, thereby preventing the spread of fire.

The inventors of this application also intend to achieve an effect of extinguishing open flames through the structural design of the fire-blocking ring and the positioning fixture. The relevant embodiments are as follows.

A fire-blocking device comprises a fire-blocking ring and a fastening fixture; the fire-blocking ring comprises an inner sheath and an outer sheath; an interlayer is provided in the outer sheath; the interlayer is filled with fire-extinguishing liquid, and the inner sheath is slidably arranged in the outer sheath; an outer edge at the top of the inner sheath and an inner edge at the bottom of the outer sheath are each provided with a blocking edge; a cavity is formed between the inner sheath and the outer sheath; a low-melting-point glue is provided at bottom of the cavity; the low-melting-point glue is used for fixing the inner sheath with the outer sheath; a liquid outlet, which is in communication with the interlayer, is provided at a lower inner part of the outer sheath; an outer end surface of the liquid outlet is in contact with an outer wall of the inner sheath; a low-melting-point sealing point is fixed at an inner end of the liquid outlet; a core material ring with a C-shaped cross-section is fixed to a lower inner part of the inner sheath; a fire-blocking core material is provided inside the core material ring; the fire-blocking core material is fixed inside the core material ring by a fireproof tape.

The inner sheath may be composed of two symmetrically arranged inner half sheaths. The outer sides of the bottom ends of the two inner half sheaths are each provided with a first positioning groove. The bottom ends between the two inner half sheaths are fixed by the first positioning grooves and a first clamp.

The outer sheath is composed of two symmetrically arranged outer half sheaths. Each of the two outer half sheaths is provided with a second positioning groove on the side surface. The two outer half sheaths are fixed by the second positioning grooves and a second clamp.

An end sheath is provided at the top of the outer sheath, and a clamping edge is provided at the side surface of the end sheath. The fastening fixture includes a pair of symmetrically arranged semi-ring bodies. The two semi-ring bodies are connected to each other by fastening bolts. A groove cooperating with the clamping edge is fixed at the lower inner portion of the semi-ring body.

The fire-blocking ring and the fastening fixture are sleeved outside the cable body of the stay cable. A silicone rubber pad is arranged inside the semi-ring bodies. The inner wall of the silicone rubber pad is in contact with the outer wall of the cable body of the stay cable. A gap is formed between the inner side of the core material ring and the outer wall of the cable body of the stay cable.

A spacing is provided at the top end of the inner sheath. The spacing is opposite to the liquid outlet.

A guide rib is provided on the side surface of the inner sheath. A notch is provided on the blocking edge. The guide ribs slide along the guide notches.

The fire-blocking device with flame-extinguishing function has the following beneficial effects.

1. The present invention designs a retractable inner sheath and outer sheath as a fire-blocking ring. The inner sheath actively moves out after the burning spreads to a certain position. At the same time, the burning spread point can be completely covered inside the inner sheath by the design of a fire-blocking core material that can expand when heated. The fire-blocking core material can be used to cut off the fire by blocking the area below the burning spread point from the fire. The fire-extinguishing liquid in the outer sheath can be used to extinguish the fire in the space between the inner sheath and the cable body of the stay cable, thereby cutting off the fire by extinguishing the fire above the burning spread point, so as to prevent the flame from spreading along the surface of the cable body. After the high-density polyethylene sheath burns, the present invention can prevent the flame from spreading along the cable body of the stay cable, and from causing more disasters.

2. The present invention adopts the design of the fire-blocking core material, which can expand when exposed to heat. After being heated, the softened or melted polyethylene sheath can be squeezed inward. It blocks the area below the burning spread point from the fire, and at the same time, blocks the space between the inner sleeve and the cable body of the stay cable, and completely restricts the burning spread point inside the inner sheath. It does not only cut off the air required for combustion but also provides space for the fire-extinguishing liquid, thus improving the fire-blocking effect of the fire-blocking ring.

3. The inner sheath and the outer sheath of the present invention are connected and fixed by a low-melting-point glue, which has a function of identifying when the fire spreads to a certain position. When the fire spreads to a position close to the fire-blocking ring, the low-melting-point glue melts actively, so that the inner sheath actively moves out to cover the spreading point.

4. The present invention uses a low-melting-point sealing to block the liquid outlet by, which has a function like a switch when the fire spreads to a certain position. When the fire spreads to a position close to the fire-blocking ring, the low-melting-point sealing point actively melts to open the liquid outlet.

5. In the present invention, each of the inner sheath, the outer sheath and the fastening fixture may be designed as two symmetrically arranged structural parts, which can be quickly installed on the cable body of the stay cable. It is convenient for the installation, removal, maintenance and replacement of the fire-blocking device, and the operation of the staff.

Of course, any product of the present embodiments does not have to achieve all of the advantages described above at the same time.

### BRIEF DESCRIPTION OF DRAWINGS

FIG. 1 is a schematic diagram of the installation of the fire-blocking device on a stay cable in Embodiment 1 of the present application;

FIG. 2 is a central cross-sectional view of the fire-blocking device in Embodiment 1 of the present application;

FIG. 3 is a central cross-sectional view of the fire-blocking-ring cylinder in Embodiment 1 of the present application;

FIG. 4 is a schematic structural diagram of the fire-blocking-ring upper cover plate or the fire-blocking-ring lower cover plate in Embodiment 1 of the present application;

FIG. 5 is a schematic structural diagram of the fire-blocking-ring shell in Embodiment 1 of the present application;

FIG. 6 is a central cross-sectional view of the assembled fire-blocking device in Embodiment 1 of the present application;

FIG. 7 is a schematic diagram of the installation of the fire-blocking device in Embodiment 1 of the present application;

FIG. 8 is a schematic structural diagram of the positioning fixture in Embodiment 1 of the present application;

In FIGS. 1-8, 1 fire-blocking ring, 2 positioning fixture, 201 connecting hole, 3 rain cover on beam end of the stay cable, 4 pre-buried pipe on beam end of the stay cable, 5 white high-density polyethylene sheath, 6 black high-density polyethylene sheath, 7 wire bundle of the stay cable, 8 weather-resistant fireproof tape, 9 fire-blocking-ring shell, 10 fire-blocking core material, 11 clamp, 12 silicone rubber, 13 screw.

FIG. 9 is a schematic structural diagram of the fire-blocking device in Embodiment 2 of the present application;

FIG. 10 is a structural cross-sectional view of the fire-blocking device in a normal state in Embodiment 2 of the present application;

FIG. 11 is a structural cross-sectional view of the fire-blocking device in Embodiment 2 of the present application;

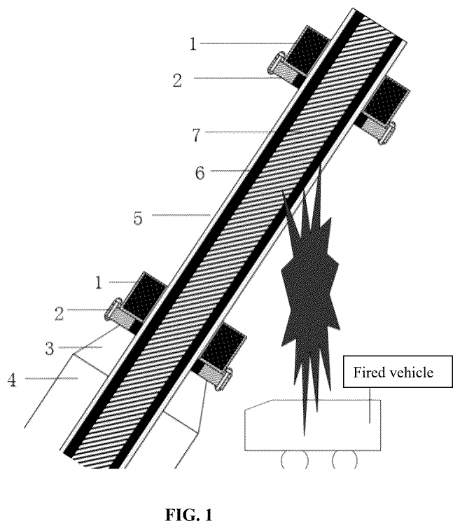

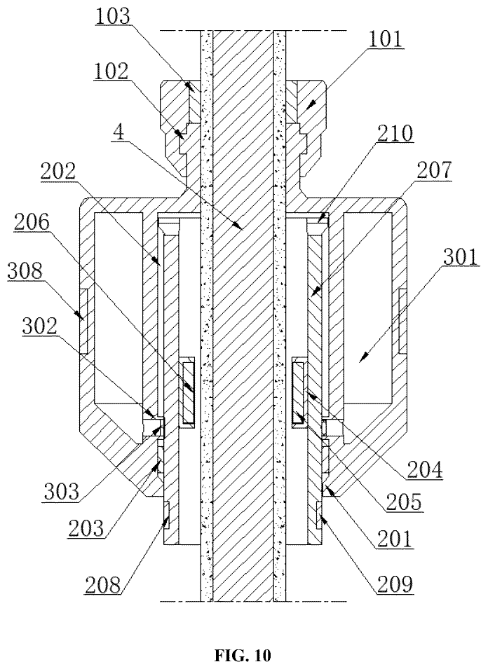

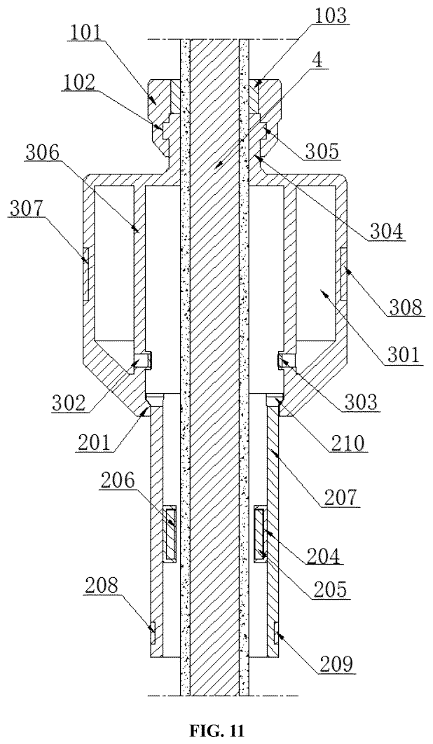

In FIGS. 9-11, 1—fastening fixture, 2—inner sheath, 3—outer sheath, 4—cable body of the stay cable, 101—semi-ring body, 102—groove, 103—silicone rubber pad, 201—blocking edge, 202—cavity, 203—low-melting-point glue, 204—core material ring, 205—fire-blocking core material, 206—fireproof tape, 207—inner half sheath, 208—first positioning groove, 209 first clamp, 210—spacing, 301—interlayer, 302—liquid outlet, 303—low-melting-point sealing point, 304—end sheath, 305—clamping edge, 306—outer half sheath, 307—second positioning groove, 308—second clamp.

### DETAILED EMBODIMENTS

The present invention will be further described in detail below with reference to the accompanying drawings. The embodiments are illustrative and intended to explain the present invention, but they cannot be understood as the limiting's of the present invention. The text description in this embodiment corresponds to the accompanying drawings, and the description of the orientation is also described on basis of the accompanying drawings, which should not be understood as limiting the scope of protection of the present invention.

### Embodiment 1

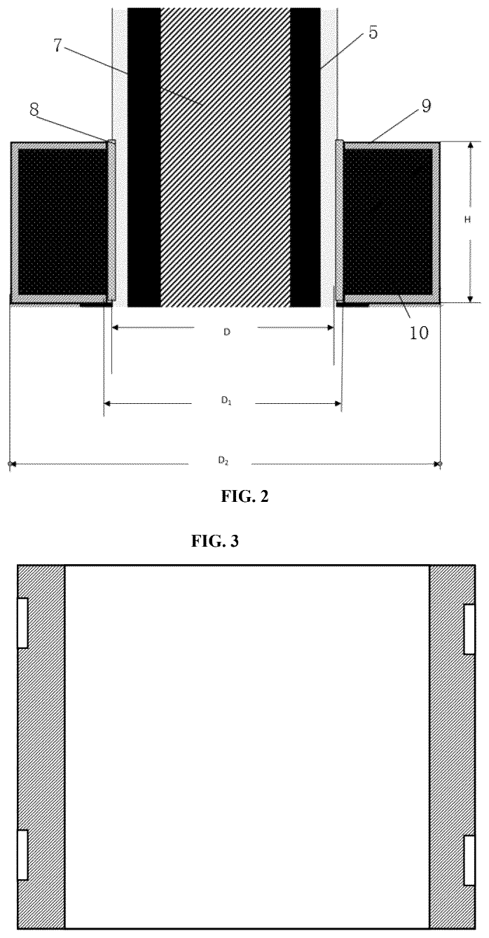

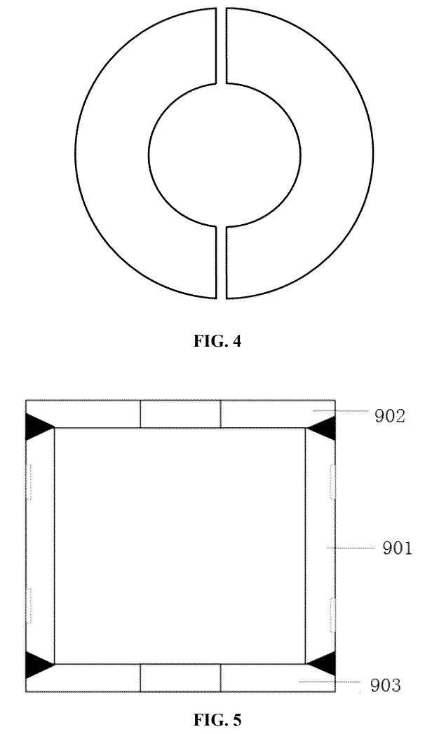

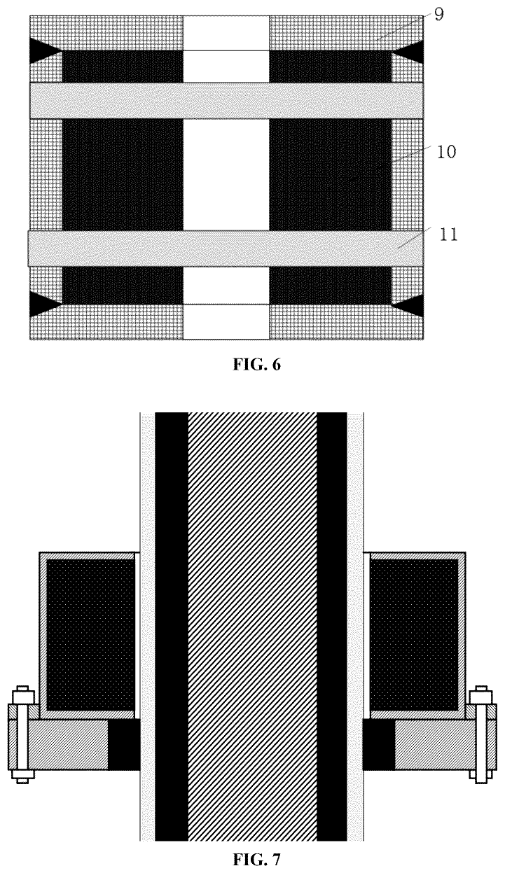

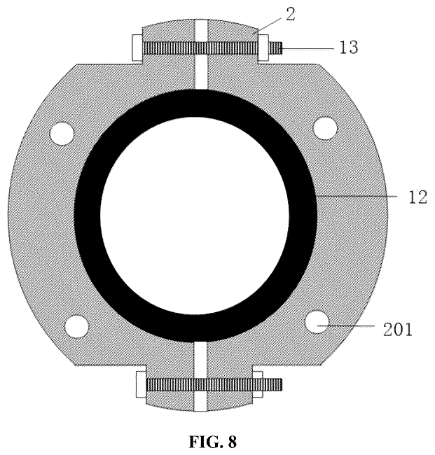

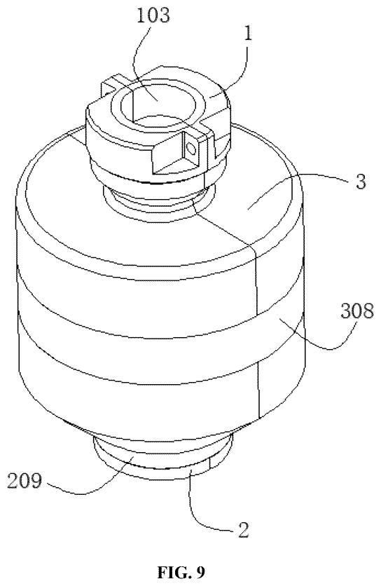

As shown in FIGS. 1-9, the fire-blocking device for a stay cable includes a fire-blocking ring 1 and a fastening fixture 2. The fire-blocking ring 1 includes a fire-blocking-ring shell 9, a fire-blocking core material 10 and a clamp 11. The principles that the fire-blocking device can prevent the fire from spreading along the high-density polyethylene sheath is as follows: when a fire occurs in a local cable body of the stay cable, the polyethylene fire-blocking-ring shell of the fire-blocking device first softens (at about 120° C.), melts (at about 180° C.), and burns (at about 345° C.). The fire-blocking core material of the fire-blocking device installed outside the polyethylene sheath of the stay cable is affected by the flame and high temperature, undergoes chemical reactions due to the heat, and expands rapidly into a dense, carbonized layer with a certain strength, which expands outward to form a huge fire-blocking ring, and at the same time squeezes the softened or melted polyethylene sheath inward. In a relatively short period of time, the holes formed by the softening or burning of the polyethylene sheath of the stay cable are sealed, which prevents the flame from spreading along the polyethylene sheath of the stay cable to the tower end or the beam end, prevents the spread of the fire, and eliminates the problem that the stay cable bearing fails, especially that the anchoring part fails prematurely, caused by the burning and spreading along the local cable body of the stay cable. The fire-blocking ring can be either integrated or half-type. When the fire-blocking device adopts an integrated fire-blocking device, the fire-blocking device may be pre-installed through the cable body before the cable is anchored.

The technical requirements for the fire-blocking device for a stay cable as well as its accessory components are as follows.

1. The fire-blocking-ring shell of the fire-blocking device is made of high-density polyethylene with a thickness of not less than 3 mm. The inner diameter of the shell is 1-3 mm larger than the outer diameter of the polyethylene sheath of the stay cable. When the polyethylene sheath of the stay cable burns, the fire-blocking-ring shell melts first, ensuring that the fire-blocking core material can expand rapidly by 20 to 40 times inward and outward at the same time, forming a huge fire-blocking ring, effectively preventing the fire from spreading along the cable body. The fire-blocking-ring shell is made of high-density polyethylene material with strong anti-aging performance. The performance parameters of the polyethylene material may be as follows.

Technical requirements for high-density polyethylene shell materials.

| | | | | Technical |
|---|---|---|---|---|
| Reference | | | | requirements |
| number | Project | | Unit | Color |
| 1 | Density | | g/cm3 | 0.940~0.955 |
| 2 | Melt mass flow rate | | g/10 min | ≤0.45 |
| 3 | Tensile breaking stress | | MPa | ≥25 |
| 4 | Tensile yield stress | | MPa | ≥15 |
| 5 | Nominal strain at break | | % | ≥400 |
| 6 | Tensile elastic modulus | | MPa | ≥500 |
| 7 | Bending elastic modulus | | MPa | <1000 |
| 8 | Impact intensity | | kJ/m2 | ≥50 |
| 9 | Shore hardness | | Shore D | ≥50 |
| 10 | Resistance to environmental stress cracking > 5000 h | | — | Pass |
| 11 | Embrittlement temperature < −76 °C | | — | Pass |
| 12 | Resistance to thermal stress cracking > 96 h | | — | Pass |
| 13 | Oxidation induction period at 200 °C | | min | ≥60 |
| 14 | Resistant to fluorescent | Change rate of tensile breaking stress | % | ±25 |
| | UV aging 3000 h | Change rate of nominal strain at break | % | ±25 |

| | | | | |
|---|---|---|---|---|
| 15 | Color fastness to light | level | — | ≥7 |

The processing method of the high-density polyethylene shell (the fire-blocking-ring shell) is as follows.
1) According to the designed size, the high-density polyethylene sheath is formed by hot extrusion, and is cut according to the required height, to form the high-density polyethylene shell cylinder of the fire-blocking device for a stay cable. Two positioning grooves with a width of 10-20 mm and a depth of 1 mm-2 mm are provided by processing on the cylinder, and the cylinder is cut along the center line.
2) According to the designed requirements, the upper/lower cover plate of the high-density polyethylene shell of the fire-blocking device is obtained by processing and is cut along the center line to form two semicircular rings.
3) A special hot melt welding gun for polyethylene or a special ultrasonic welding gun for polyethylene is used to weld the upper and lower cover plates and the cylinder of the high-density polyethylene shell into a whole, to form a high-density polyethylene shell of the fire-blocking device, that is, a fire-blocking-ring shell.

2. The fire-blocking core material of the fire-blocking device can be a chemical intumescent flame retardant or a physical intumescent flame retardant.

Chemical intumescent flame retardant may be composed of three parts: acid source (dehydrating agent), carbon source (carbon forming agent), and gas source (foaming agent). The acid source is mainly phosphorus oxychloride phosphate, ammonium polyphosphate, etc. The carbon source is mainly polyhydroxy compounds or carbohydrates with high carbon content, which is the basis for forming the foam carbonized layer. It may be a polyhydroxy compound with high carbon content, such as phenolic resin, polyamide, tetramethylene glycol, maltose, starch, etc. Gas source is also called foaming source. A commonly used foaming source may be melamine, dicyandiamide, ammonium polyphosphate, urea, etc. The above gas source materials can release a large amount of non-flammable gas when decomposed by heat, and the foaming effect is to expand the carbonized layer. As above, the flame retardant mechanism of chemical intumescent flame retardant is: when heated, the acid source decomposes to produce a dehydrating agent, which can form an ester with a carbon forming agent. The ester is then dehydrated and cross-linked to form carbon. Meanwhile, the foaming agent releases a large amount of gas to help the carbon layer to expand. The thick carbon layer can increase the temperature gradient between the polymer surface and the carbon layer surface, make the polymer surface temperature much lower than the flame temperature, reduce the possibility of further degradation of the polymer to release combustible gases, and at the same time isolate the entry of external oxygen, thus it can have a flame retardant effect on the polymer for a considerable period of time.

The core material of the fire-blocking device may also use a physically-expandable graphite material. At a high temperature, the expandable graphite expands rapidly to extinguish the flame. At the same time, the generated expanded graphite material covers the surface of the substrate, isolating the thermal radiation and oxygen contact. During expansion, the acid radicals inside the interlayer are released, which also promotes the carbonization of the substrate. Thereby, a variety of flame blocking manners are used to achieve a good result.

When heated, the expansion volume of the fire-blocking core material of the fire-blocking device can reach 20 to 40 times its original volume.

The fire-blocking core material of the fire-blocking device adopts a semi-ring shape, and the relevant dimensions of the ring shape are determined according to the following table.

| | Inner diameter D1 of | Outer diameter D2 of | Height H of the |
|---|---|---|---|
| Outer diameter D of | fire-blocking core | fire-blocking core | fire-blocking core |
| stay cable | material | material | material |
| D ≤ 110 mm | D + 1 mm | D + 21 mm | 60-80 mm |
| 110 mm < D ≤ 160 mm | D + 2 mm | D + 32 mm | 70-90 mm |
| 160 mm < D ≤ 210 mm | D + 2 mm | D + 42 mm | 80-100 mm |
| 210 mm < D | D + 3 mm | D + 43 mm | 90-110 mm |

The schematic diagram of the assembled fire-blocking device is shown in FIG. 6.

3. In order to prevent the fire-blocking device shell and fire-blocking core material from colliding and rubbing against the high-density polyethylene sheath during the service of the stay cable, a 3-6 mm thick weather-resistant fireproof tape (such as polyvinyl fluoride tape) should be wrapped around the location where the fire-blocking device is installed.

4. In order to prevent the fire-blocking ring from falling off, the fire-blocking-ring shell is provided with a flange with holes, which is connected with the positioning fixture below to achieve the positioning of the fire-blocking ring and prevent the fire-blocking ring from slipping and falling off during the service of the cable-stayed bridge. A half-type positioning fixture of the fire-blocking device can be installed before the stay cable is anchored, or after the stay cable is anchored or erected.

5. A positioning fixture 2 is provided at the lower end of the fire-blocking device. The positioning fixture adopts a half-type structure, and the two components are connected by a screw 13. In order to protect the polyethylene sheath of the stay cable from being damaged by the positioning fixture, a silicone rubber 12 with a thickness of 5 mm to 10 mm and a Shore hardness of 50 to 60 is provided in the inner hole of the positioning fixture.

### Embodiment 2

As shown in FIGS. 9-11, the present embodiment relates to a fire-blocking device capable of extinguishing an open flame, including a fire-blocking ring and a fastening fixture 1. The fire-blocking ring includes an inner sheath 2 and an outer sheath 3. An interlayer 301 is provided inside the outer sheath 3. The interlayer 301 is filled with a fire-extinguishing liquid (such as clean water or fine sand). The inner sheath 2 is slidably disposed inside the outer sheath 3. The outer edge at the top of the inner sheath 2 and the inner edge at the bottom of the outer sheath 3 are each provided with a blocking edge 201. A cavity 202 is formed between the inner sheath 2 and the outer sheath 3. A low-melting-point glue 203 is provided at the bottom of the cavity 202. The inner sheath 2 and the outer sheath 3 are fixed through the low-melting-point glue 203. A liquid outlet 302 in communication with the interlayer 301 is provided at the lower inner part of the outer sheath 3. The outer end surface of the liquid outlet 302 is in contact with the outer wall of the inner sheath 2. A low-melting-point sealing point 303 is fixed at the inner end of the liquid outlet 302. A core material ring 204 with a C-shaped cross-section is fixed to the lower inner part of the inner sheath 2. A fire-blocking core material 205 is provided inside the core material ring 204. The fire-blocking core material 205 is fixed inside the core material ring 204 by a fireproof tape 206 (for example, a polyvinyl fluoride tape).

The inner sheath 2 may be composed of two symmetrically arranged inner half sheaths 207. The outer sides of the bottom ends of the two inner half sheaths 207 are each provided with a first positioning groove 208. The bottom ends between the two inner half sheaths 207 are fixed by the first positioning grooves 208 and a first clamp 209. A spacing 210 is provided at the top end of the inner sheath 2. The spacing 210 is opposite to the liquid outlet 302. A guide rib is provided on the side surface of the inner sheath 2. A notch is provided on the blocking edge 201. The guide ribs slide along the guide notches.

The outer sheath 3 is composed of two symmetrically arranged outer half sheaths 306. Each of the two outer half sheaths 306 is provided with a second positioning groove 307 on the side surface. The two outer half sheaths 306 are fixed by the second positioning grooves 307 and a second clamp 308. An end sheath 304 is provided at the top of the outer sheath 3 and a clamping edge 305 is provided at the side surface of the end sheath 304. The fastening fixture 1 includes a pair of symmetrically arranged semi-ring bodies 101. The two semi-ring bodies 101 are connected to each other by fastening bolts. A groove 102 cooperating with the clamping edge 305 is fixed at the lower inner portion of the semi-ring body 101.

The fire-blocking ring and the fastening fixture 1 are sleeved outside the cable body 4 of the stay cable. A silicone rubber pad 103 is arranged inside the semi-ring bodies 101. The inner wall of the silicone rubber pad 103 is in contact with the outer wall of the cable body 4 of the stay cable. A gap is formed between the inner side of the core material ring 204 and the outer wall of the cable body 4 of the stay cable.

The working principles of the fire-blocking device in the present embodiment are as below.

When a fire occurs in the sheath layer on the surface of the cable body 4 of the stay cable and spreads to a position close to the device, the low-melting-point glue 203 and the low-melting-point sealing point 303 will be melted in advance as the combustion temperature is conducted. The low-melting-point sealing point 303 is a sealing point formed by the low-melting-point glue. In the high temperature environment caused by the flame, the low-melting-point glue will melt.

The melting of the low-melting-point glue 203 will release the bond between the inner sheath 2 and the outer sheath 3, and the inner sheath 2 will fall due to gravity. At this time, the spreading burning point is inside the inner sheath 2 and is located above the fire-blocking core material 205, thereby the burning point can be wrapped inside the inner sheath body 2. The fireproof tape 206 melts with high temperature and the fire-blocking core material 205 expands due to heat. The inner side of the expanded fire-blocking core material 205 wraps the outer side of the burned cable body which is located below the burning point.

The melting of the low-melting-point sealing point 303 is equivalent to opening the liquid outlet 302. During the process that the inner sheath 2 is sliding downward along the outer sheath 3, the end of the liquid outlet 302 is in contact with the outer wall of the inner sheath 2 and continues to be blocked to a certain extent. After the inner sheath 2 falls completely, the liquid outlet 302 is exposed to outside. The fire-extinguishing liquid in the interlayer 301 is discharged under gravity to the gap between the inner sheath 2 and the cable body 4 of the stay cable, and the bottom of the gap is blocked by the expanded fire-blocking core material 205. Therefore, the burning point retained in the inner sheath 2 can be extinguished and flame-retarded, and the spread of the burning point can be directly cut off.

1. A fire-blocking device for a stay cable capable of achieving bidirectional expansion when exposed to heat, characterized in comprising a fire-blocking ring and a positioning fixture; the fire-blocking ring is fixed on surface of a cable body of the stay cable through the positioning fixture, and the fire-blocking ring wraps the cable body of the stay cable; if being heated, the fire-blocking ring expands inward to hug the cable body of the stay cable, and expands outward to separate the cable bodies of the stay cable on two sides of the fire-blocking ring.

2. The fire-blocking device of claim 1 for a stay cable capable of achieving bidirectional expansion when exposed to heat, wherein
the fire-blocking ring has an integrated structure, and the cable body of the stay cable passes through the fire-blocking ring;
or the fire-blocking ring has a half-type structure, and is arranged around the cable body of the stay cable.

3. The fire-blocking device of claim 1 for a stay cable capable of achieving bidirectional expansion when exposed to heat, wherein
a weather-resistant fireproof tape is wound around the cable body of the stay cable where the fire-blocking ring is provided; the fire-blocking ring is arranged at an outer side of the fireproof tape.

4. The fire-blocking device of claim 1 for a stay cable capable of achieving bidirectional expansion when exposed to heat, wherein
the fire-blocking ring comprises a fire-blocking-ring shell, a fire-blocking core material and a clamp; the fire-blocking core material is arranged inside the fire-blocking-ring shell; the clamp is clamped outside the fire-blocking-ring shell.

5. The fire-blocking device of claim 4 for a stay cable capable of achieving bidirectional expansion when exposed to heat, wherein
the fire-blocking core material has an annular structure; the fire-blocking-ring shell has a hollow annular structure; the fire-blocking-ring shell comprises a fire-blocking-ring cylinder, a fire-blocking-ring upper cover plate, and a fire-blocking-ring lower cover plate; the fire-blocking core material is arranged inside the fire-blocking-ring cylinder; the fire-blocking-ring upper cover plate and the fire-blocking-ring lower cover plate are respectively arranged at an upper opening and a lower opening of the fire-blocking-ring cylinder; a sealing ring is arranged at a joint to fix the fire-blocking core material inside the fire-blocking-ring cylinder.

6. The fire-blocking device of claim 4 for a stay cable capable of achieving bidirectional expansion when exposed to heat, wherein
the fire-blocking-ring shell is made of high-density polyethylene with a thickness of not less than 3 mm; the inner diameter of the fire-blocking-ring shell is 1 to 3 mm larger than the outer diameter of the stay cable;
an inner diameter D1, an outer diameter D2 and a height H of the fire-blocking core material are set as shown in following table.

| | Inner diameter D1 of | Outer diameter D2 of | Height H of the |
|---|---|---|---|
| Outer diameter D of | the fire-blocking core | the fire-blocking core | fire-blocking core |
| stay cable | material | material | material |
| D ≤ 110 mm | D + 1 mm | D + 21 mm | 60-80 mm |
| 110 mm < D ≤ 160 mm | D + 2 mm | D + 32 mm | 70-90 mm |
| 160 mm < D ≤ 210 mm | D + 2 mm | D + 42 mm | 80-100 mm |
| 210 mm < D | D + 3 mm | D + 43 mm | 90-110 mm |

7. The fire-blocking device of claim 1 for a stay cable capable of achieving bidirectional expansion when exposed to heat, wherein
a positioning groove is provided by processing on surface of the fire-blocking-ring shell; the positioning groove is used for arranging a clamp; the clamp fixes the fire-blocking-ring shell of the half-type structure as a whole.

8. The fire-blocking device of claim 1 for a stay cable capable of achieving bidirectional expansion when exposed to heat, wherein
the positioning fixture is arranged at a lower end of the fire-blocking ring, so that a bottom of the fire-blocking ring is supported by the positioning fixture; the positioning fixture has a half-type structure, embracing outside the cable body of the stay cable; the positioning fixture has an inner hole provided with silicone rubber with a thickness of 5 mm to 10 mm; the silicone rubber is provided outside the cable body of the stay cable.

9. The fire-blocking device of claim 8 for a stay cable capable of achieving bidirectional expansion when exposed to heat, wherein
a connecting hole is provided on the surface of the positioning fixture; the positioning fixture is connected to the fire-blocking ring by arranging a connecting member in the connecting hole, or by providing a limiting member in the connecting hole to form an external limit to the fire-blocking ring.

10. The fire-blocking device of claim 1 for a stay cable capable of achieving bidirectional expansion when exposed to heat, wherein
the positioning fixture is a fastening fixture; the fire-blocking ring comprises an inner sheath and an outer sheath; an interlayer is provided in the outer sheath; the interlayer is filled with fire-extinguishing liquid, and the inner sheath is slidably arranged in the outer sheath; an outer edge at the top of the inner sheath and an inner edge at the bottom of the outer sheath are each provided with a blocking edge; a cavity is formed between the inner sheath and the outer sheath; a low-melting-point glue is provided at bottom of the cavity; the low-melting-point glue is used for fixing the inner sheath with the outer sheath; a liquid outlet, which is in communication with the interlayer, is provided at a lower inner part of the outer sheath; an outer end surface of the liquid outlet is in contact with an outer wall of the inner sheath; a low-melting-point sealing point is fixed at an inner end of the liquid outlet; a core material ring with a C-shaped cross-section is fixed to a lower inner part of the inner sheath; a fire-blocking core material is provided inside the core material ring; the fire-blocking core material is fixed inside the core material ring by a fireproof tape.
